(19) United States
(12) Patent Application Publication
(10) Pub. No.: US 2018/0217970 A1
(43) Pub. Date: Aug. 2, 2018

(54) METHODS AND SYSTEMS FOR PROCESSING INTUITIVE INTERACTIVE INPUTS ACROSS A NOTE-TAKING INTERFACE

(71) Applicant: VOOLAB TECHNOLOGIES PRIVATE LIMITED, Bengaluru (IN)

(72) Inventors: Sumit Dev, Bengaluru (IN); Kishor Jinde, Bengaluru (IN)

(21) Appl. No.: 15/418,734

(22) Filed: Jan. 29, 2017

(51) Int. Cl. G06F 17/24; G06F 3/0488

(52) U.S. Cl. CPC G06F 17/243; G06F 3/04883

(57) ABSTRACT

The invention claims and discloses a digital form generating and filling interface system comprising: at least one touch-device input; a scribe controller processing each touch-device input and generating at least one messaging event for generation of at least one form domain, field, and entry, said scribe controller further comprising; a character and word (C/W) recognition block; a form domain block; a field entry block; a program executable by the scribe controller and configured to: accept any one of a touch-input from any one of a user device touch-screen, wherein the touch-input generates either a script layer or drawing stroke layer; receive any one of a script or drawing stroke touch-input into any one of the script layer or drawing stroke layer; recognize any one of the script or drawing stroke layer input and render into a messaging event for conversion into any one of a standard font text or re-scaled drawing by the C/W recognition block; render the messaging event into any one of a field, super-ceded by a field domain by the form domain block; translate the messaging event into any one of the standard font text or re-scaled drawing by any of the script-to-text conversion layer or stroke conversion layer of the form entry block; and populate a chosen field with any one of the standard font text or re-scaled drawing by anyone of a script and, or stroke link layer of the form entry block.

### TECHNICAL FIELD

The invention relates to methods and systems for processing for processing interactive inputs across a note-taking interface. More particularly, the primary purpose of the disclosure is ease of use of note-taking as well as the speed and fidelity of conversion of the note-taking into an appropriate format. More importantly, the disclosure also discloses an automatic and a fluid form building as well as a fluid entry into the field domain.

### BACKGROUND

In the two decades, the use of personal computing devices, such as desktops, laptops, handheld computers systems, tablet computer systems, touch screen phones have grown tremendously, which provide users with a variety of interactive applications, business utilities, communication abilities, and entertainment possibilities.

Current personal computing devices in the market provide access to these interactive applications via a user interface. Typical computing devices have on-screen graphical interfaces that present information to a user using a display device, such as a monitor or display screen, and receive information from a user using an input device, such as a mouse, a keyboard, a joystick, stylus or a finger-touch.

Even more so than computing systems, the use of pen and paper is ubiquitous among literate societies and the western world. While graphical user interfaces of current computing devices provide for effective interaction with many computing applications, typical on-screen graphical user interfaces have difficulty mimicking the common use of a pen or pencil and paper. These handwriting inputs from the pen to paper format may be left in graphics form for insertion into a form or a document or the handwriting inputs may be converted to machine text, for example, rendered in an optical character recognition-like procedure to fonts available to a particular application. Moreover, the input into a computer is shown on an electronic display, and is not tangible and accessible like information written on paper or a physical surface.

U.S. Pat. No. 9,524,428B2, titled “Automated handwriting input for entry fields”, assigned to Lenovo (Singapore) Pte Ltd, provides a method, comprising: detecting, at a surface of a device accepting handwriting input, a location of the display surface associated with initiation of a handwriting input; determining, using a processor, a location of an entry field in a document rendered on a display surface, the location of the entry field being associated with a display surface location; determining, using a processor, a distance between the location of the surface associated with initiation of the handwriting input and the location of the entry field; and automatically inserting input, based on the handwriting input, into the entry field after determining the distance is less than a threshold value. More importantly, the input is only inserted into its appropriate field automatically only when the distance is less than a certain threshold value. It fails to create an easy to use, fluid form building capability for the use

### SUMMARY

Method and system for processing interactive inputs across a note-taking interface. In an embodiment of the invention, a digital form generating and filling interface system comprises of a touch-device input, a scribe controller processing each touch-device input and generating a messaging event for generation of at least one form domain, field, and entry. The scribe controller further comprises of a character and word (C/W) recognition block, a form domain block, a field entry block and a program executable by the scribe controller configured to accept a touch-input from any one of a user device touch-screen, wherein the touch-input generates either a script layer or drawing stroke layer to receive any one of a script or drawing stroke touch-input into any one of the script layer or drawing stroke layer and further, recognize any one of the script or drawing stroke layer input and render into a messaging event for conversion into any one of a standard font text or re-scaled drawing by the C/W recognition block.

In yet another embodiment of the invention, the rendering of the messaging event into any one of a field is superseded by a field domain and the form domain block. Further yet, subsequently, the translation of the messaging event into any one of the standard font text or re-scaled drawing by any of the script-to-text conversion layer or stroke conversion layer of the form entry block takes place and finally, population of a chosen field with any one of the standard font text or re-scaled drawing by anyone of a script and, or stroke link layer of the form entry block.

### BRIEF DESCRIPTION OF DRAWINGS

FIG. 1 illustrates an exemplary system in which various embodiments of the disclosure can be practiced.

FIG. 2 illustrates an exemplary network according to an embodiment of the disclosure.

FIG. 3 shows various components of a scribe controller according to an embodiment of the invention.

FIG. 4 shows various components of the scribe controller according to an aspect of the invention.

FIG. 5 illustrates an exemplary interaction flow in which various embodiments of the disclosure can be practiced.

FIG. 6 illustrates an exemplary process flow according to an embodiment of the invention.

FIG. 7a illustrates an exemplary user interface according to an embodiment of the invention.

FIG. 7b show a user interface according to an exemplary embodiment of the invention.

FIG. 7c illustrates an exemplary user interface according to an embodiment of the invention.

FIG. 7d how a user interface according to an exemplary embodiment of the invention.

FIG. 7e illustrates an exemplary user interface according to an embodiment of the invention.

FIG. 7f show a user interface according to an exemplary embodiment of the invention.

FIG. 8 depicts a method flowchart for processing the touch inputs into form and text across the scribe controller in accordance with an aspect of the invention.

### DETAILED DESCRIPTION OF DRAWINGS

The present invention will now be described more fully with reference to the accompanying drawings, in which embodiments of the invention are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

### Overview:

The primary purpose of the disclosure is to enable a collaborative interface to receive and convert multiple independent touch inputs, over a network, simultaneously in real time to build and fill a savable, searchable, and shareable form. Devices may include any one of computer, hand-held device, tablet, and, or any device with a processor and a display. Inputs may include any one of finger-point script or drawing stroke control, and, or gesture-led control. Once a user is invited to a session, each user may have a full display space to script a command for a conversion into a form field domain. The user then has the full display space to script for conversion into a field entry for the respective field domain. The user may also employ a separate a drawing stroke layer with full-display space for conversion and entry into the field entry for the respective field domain. The spaces in which the user or any other user/s are active in may be denoted. Furthermore, field domains and order may be intelligently suggested based on user dynamics or a pre-defined ordering rule. The use of tools may be prompted by the system intelligently based on the space in which the tool resides, based on individual use, and, or group use and behavior. Assembled forms may be stored under titled files and retrieved for future reference. Files may be integrated into the cloud for analytics and a host of any number of downstream provisioning. A scalable platform with 3rd-party, API-gated application integration is possible, for enriched downstream outcomes, such as co-interfacing across applications, browsers, and tools to create additional workflow efficiencies.

### Exemplary Environment

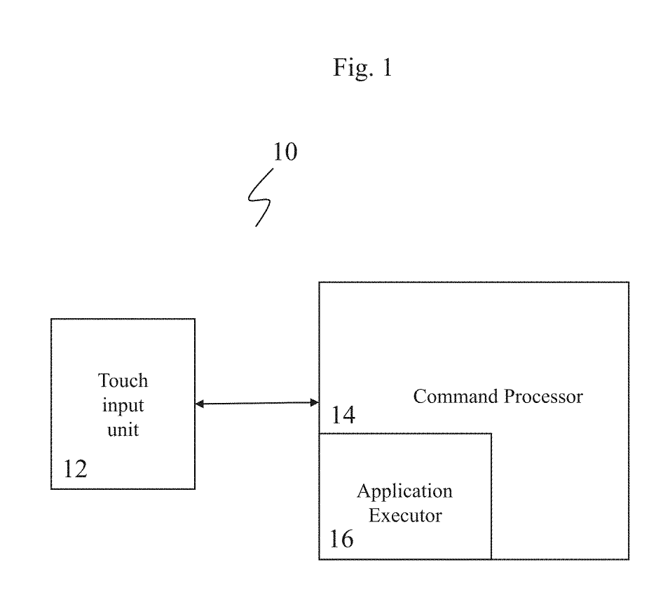

FIG. 1 illustrates an exemplary environment 10 in which various embodiments of the present invention can be practiced. The environment 10 includes a touch input unit 12, processor 14, and application executor 16 within a computing device, which is communicatively coupled to the server, and more specifically, the scribe controller, over a network.

As shown, the computing device refers to any electronic device which is capable of sending, receiving and processing information. Examples of the computing device include, but are not limited to, a smartphone, a mobile device/phone, a Personal Digital Assistant (PDA), a computer, a workstation, a notebook, a mainframe computer, a laptop, a tablet, a smart watch, an internet appliance and any equivalent device capable of processing, sending and receiving data. The user may use the computing device and digital note-taking interface for his or her day-to-day note-taking or recordation tasks, such as patient notes during a medical consultation. In the context of the present invention, wherein each defined space may be fully displayed and sequentially overlaid or integrated with any one of the other interactive tool layers, whereby any or all touch inputs have any one of a script, marking, text, and, or structured drawing display across any one of a defined space or tool layer. A stylus may be the preferred implement to achieve this digital form building and entry function. Touch input means may be the digits of a user's hand as well.

In continuing reference to FIG. 1, the touch input unit 12 recognizes a command and processes input from the user and provides the recognized command to the application executer 16. In addition to an input function, the touch input unit 12 may also figure prominently in displaying the requested data structure/output on a user device display. As far as a touch input means, the touch input unit 12 may be configured for being receptive to the touch of a stylus, pointed implement, or the digit/s of a user's hand.

Preferably, once installed, the application executor 16 initiates and controls the application according to an external command. The application executer 16 outputs the result of the instruction encoded by the processor 14 via the touch input unit, or alternatively, directly via the device display. Examples of memory include, but are not limited to, magnetic tapes, magnetic drums, magnetic disks, CDs, optical storage, RAM, ROM, EEPROM, EPROM, flash memory, or any other suitable storage media. Memory may be fixed or removable. Devices may be connected to a scribe controller via at least one of, a cloud based server connected to a network, serial port, USB port, or PS/2 port, or other connection types. Devices may be connected to the scribe controller via wire, IR, wireless, or remotely, such as over the Internet, cloud based server connected to a network and other means. The methods described herein are best facilitated in software code installed and operated on a processor as part of the cloud based server connected to a network. A program executable by the processor 14, along with a scribe controller, is configured to process each touch-device input via the touch input unit 12 and application executor 16 to generate at least one messaging event for generation of at least one form domain, field, and entry.

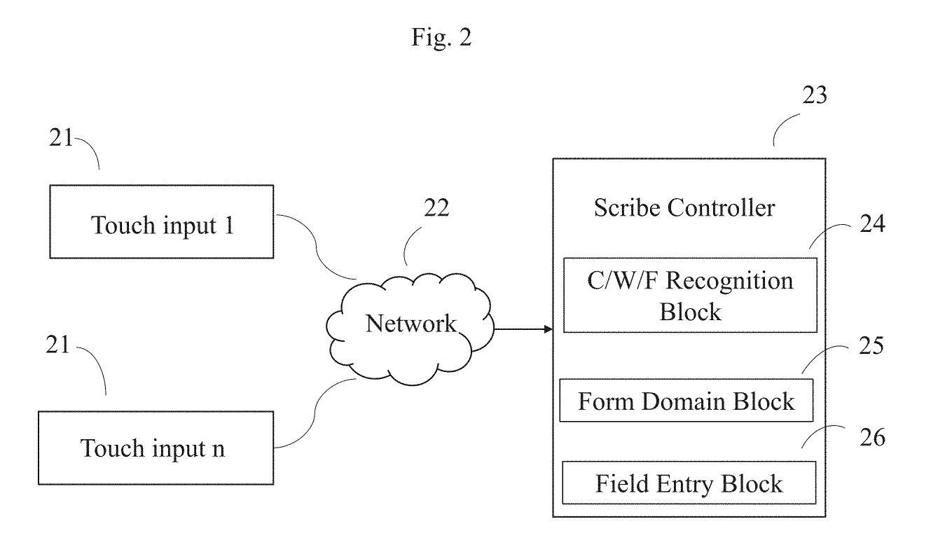

Now in reference to FIG. 2, the network 22 may be any other type of network that is capable of transmitting or receiving data to/from/between user devices: computers, personal devices, telephones or any other electronic devices. Moreover, the network 22 may be any suitable wired network, wireless network, a combination of these or any other conventional network, including any one of, or combination of a LAN or wireless LAN connection, an Internet connection, a point-to-point connection, or other network connection—either local, regional, or global. As such, the network 22 may be further configured with a hub, router, node, and, or gateway to serve as a transit point or bridge to pass data between any of the at least networks. The network 22 may include any software, hardware, or computer applications that implement a communication protocol (wide or short) or facilitate the exchange of data in any of the formats known in any art, at any time. In some embodiments, any one of a hub, router, node, and, or gateway may additionally be configured for receiving wearable or IoT data of a member of a group session, and such data may be saved, shared, or embedded within the session. Additionally, such personalized or contextual data may further inform the suggestion tool layer or automation tool layer on suggesting reactive or proactive routines within the workflow.

In continuing reference to FIG. 2, the network-coupled server, cloud-based server, or scribe controller 23 may be a device capable of processing information received from the independent user touch input 21. Other functionalities of the server or controller 23 include providing a data storage, computing, communicating and searching. As shown in FIG. 2, the server or scribe controller 23 processes the input, recognizes the script or marking input, and translates it into standard font text, marking or structured drawing to be populated into a dynamically generated form and its respective field.

In other embodiments, the scribe controller 23 receives the touch input, computes a signature of the independent user and assigns a unique identifying characteristic in the form of nomenclature, alpha-numeric identifier, and, or cursor color and displays across each and every space and tool layer. In other embodiments, the server/controller 23 may have a RESTful Application Program Interface (API) coupled to client side adapted code that delivers each client side API pathway that specifically suits the client—based on context and load. This allows for 3rd party database integration, such as Electronic Medical Records (EMR) and other downstream analytics and provisioning. The scribe controller 23 also allows for easy saving, searching, and sharing of form information with authorized participants. Alternatively, sharing may be possible with less discrimination based on select privacy filters.

### Exemplary Scribe Controller:

As FIGS. 2, 3, and 4 illustrate, the scribe controller 23, 33, 43 further comprises a character, word, and figure (C/W/F) recognition block 24, 34, 44; a form domain block 25, 35, 45; a field entry block 26, 36, 46. In alternative embodiments, translation of recognized script and, or marking is achieved by a single form block, further comprising field domain and field entry layers or modules.

Furthermore, the scribe controller 23, 33, 43 accepts any one of a touch-input from any one of a user device touch-screen, wherein the scribe controller 23,33, 43, and in particular, the C/W/F recognition block 24, 34, 44 receives any one of a script or marking touch-input into any one of an ink layer 44a. The ink layer 44a recognizes any one of the script or marking input and renders it into a messaging event for conversion into any one of a standard font text, marking or structured/re-scaled drawing.

This messaging event is eventually translated into any one of a field, superseded by a field domain by the form domain block 25, 35, 45. Once a form field is established with a domain, then the field entry block 26, 36, 46 translates a messaging event from a second recognized touch input command into any one of the standard font text, marking or re-scaled drawing by any of a print layer 46a, 46b. In an alternative embodiment, the field entry may be recognized and translated first, followed by establishing the form field and field domain.

The field entry block 26, 36, 46 may populate a chosen field with any one of the standard font text, marking or re-scaled drawing by anyone of a script 46b and, or stroke link layer 46d of the field entry block 26, 36, 46. In a preferred embodiment, field population may be performed by the order set by a pre-defined rule. The pre-defined rule may be tailored to the user application. Alternatively, field population may be dictated by the sequence order of script or marking touch input by a user or learned user input history.

Still in reference to the system components of the scribe controller 23,33,43, the C/W/F recognition block 24, 34, 44 further comprises a link layer 44a. In a preferred embodiment, the link layer 44a may further comprise of a print script recognition layer; cursive recognition layer; and a marking recognition layer. In some embodiments, the C/W/F recognition block 24, 34, 44 may further comprise an optical character recognition layer 44b. In other embodiments, the C/W/F recognition block 24, 34, 44 may further comprise a heuristic layer 44c and a semantic layer 44d.

In some embodiments, the heuristic layer 44c may allow for shorthand script and, or other symbols that are conventional lexicon, to be recognized and translated for text conversion. An example of a shorthand script or symbol, such as “→” in a script construct may be recognized by the heuristic layer 44c to be converted into a candidate of text words, including “next, proceed, followed by”, etc. In yet other embodiments, the heuristic layer 44c may work in conjunction with the print script recognition layer or the cursive recognition layer of the ink layer 44a in order to recognize the shorthand or symbol in context.

For example:
[symbol] (8:20→3:30)
   Recognized and converted into the following text:

“Departing LaGuardia Airport (NYC) at 8:20 EST; arriving at San Francisco International Airport (San Francisco) at 3:30 pm PST.”

As exemplified, the arrow symbol, “→”, represents two different set of candidate terms based on the context. While in isolation, the arrow symbol may perhaps trigger the display of the candidate terms, “next, proceed, enter”, etc. As exemplified, the arrow symbol in context of airport codes and times trigger display of “Departing LaGuardia Airport (NYC) at 8:20; arriving at San Francisco International Airport (San Francisco) at 3:30 pm PST. In other embodiments, the recognition layers 44a may recognize the symbols or shorthand in isolation or context, without the aid of the heuristic layer 44c.

In some embodiments, a semantic layer 44d may recognize and, or convert—in isolation, or in conjunction with the ink layer 44a—written vernacular into form-filled language.

For example:

[symbol]

[symbol]

[symbol]

[symbol]

[symbol] may be recognized and converted by the semantic layer 44d into the following form-filled language: Departing from LaGuardia in the evening and arriving into San Francisco the following morning. As with the heuristic layer 44c, the semantic layer 44d may be operably coupled with the ink layer 44a, or may operate in isolation, in order to output a form-filled text from everyday colloquy or natural language syntax. In other embodiments, this form-filled output from an everyday colloquy input may be effectuated by the ink layer 44a.

In continuing reference to the heuristic 44c and semantic layers 44d of the C/W/F recognition block 24, 34, 44, the heuristic layer 44c/semantic layer 44d may recognize short-hand script for any one of a translation into a field domain by the form domain block 25, 35, 45 or text conversion for entry into a field by the field entry block 26, 36, 46. Furthermore, the semantic layer 44d may recognize natural language syntax from a recognized print or cursive input for conversion for entry into a field by the field entry block 26,36, 46 and field domain generation by the form domain block 25, 35, 45.

The layers of the C/W/F recognition block 24, 34, 44: ink 44a (print script, cursive script, marking); optical character 44b; heuristic 44c; and semantic 44d may employ machine learning techniques to recognize cursive script, print script, and marking input. Furthermore, recognition updates from machine learning may continually, or in fixed intervals, update a library of recognized cursive or print script input. Library updates may also be done without machine learning and may be inputted.

While not shown, the C/W/F recognition block 24, 34, 44 may further comprise a candidate layer, whereby the candidate layer displays a drop down of at least one recognition candidate based on any one of the script or marking touch input. In other embodiments, a list of candidates may be appearing in drop down form or in any other display form. Furthermore, any one of the candidate display may be produced by any one of the print, cursive, or marking sub-layers of the ink layer 44a. Candidate terms may be queried from a library of recognized cursive or print input, wherein library updates are methodical or dynamic.

Although not show, the C/W/F recognition block 24. 34. 44 may further comprise of a cessation layer, wherein said cessation layer detects a cessation of any one of a marking, cursive, or print script input, and communicates to any one of the form domain block 25, 35, 45 and, or field entry block 26, 36, 46 to finalize a first field domain and, or field entry and initiate a second field domain and, or field entry. In further detail, cessation may be any period of time, for instance, one second, in order to trigger transition from one script or marking display to form display. In other embodiments, other cues, other than cessation may be used to trigger initiation of a new domain and, or field entry. For instance, a specific touch input on specific areas of a display window may serve as the requisite transition trigger. Other intuitive transition triggers may be employed, such as a gesture-based input, etc.

In further detail of the C/W/F block 24, 34, 44, the marking sub-layer of the ink layer 44a, may cross-check a pre-defined library of images in order to generate an auto-corrected or structured drawing. In events where the marking sub-layer is simply converting 1:1 input: output, the marking sub-layer may not need to be operably coupled to a cache of reference images. Additionally, marking sub-layers that are re-scaling, but not re-structuring, marking input, may also, not require an image cross-reference. Again, as in other instances of a library reference, the marking sub-layer may employ machine learning techniques to recognize and convert marking image input.

In other embodiments (not shown), each of the display windows or spaces (script/marking input or form build/print) may further be over laid with any one of, or combination of the following tool layer: voice-to-text, voice-to-scribe, and voice-to-media; and a session save, query, and retrieve layer. Once in a space, each space may further be enriched with an imposition of a layer. Sessions may be stored under titled files and retrieved for future reference. The use of tools may be prompted or suggested by the system intelligently based on the space in which the tool resides, based on individual use and behavior. Tool prompting and suggested use may also be based on a pre-defined rule or criteria. Tool and, or display space prompting may be done in the form of a chatbot or a de novo messaging means.

In another embodiment of the invention, the C/W/F recognition block may be operably coupled to a translation module (not shown) to which is involved in the translation of the touch inputs into different languages. Also, the translation module may be involved in translation of different languages, characters or words into the English language or a plurality of languages simultaneously and automatically inserts the input information for a fluid form building/entry.

In one embodiment, a text box or chat box layer may include a private textbox, only visible to the respective user. The layer may also include a group-wide textbox, each textbox designated to the respective user, and visible to the entire group. Text boxes may be designated with a color-code identifier corresponding to the color code of each respective user. Alternatively, the text box may be user designated by any one of user identifier or nomenclature. In yet other embodiments, the text box or chat box layer may display a private note box, along with one other text box, visible to the group. This one text box may allow users to input text into the single display, and each user may be designated by any one of a user identifier, nomenclature, and, or user-specific color-code. Scenarios of group texting with respect to the application may involve a physician consultation, wherein the physician is in the process of examining a patient, while still in need of communicating essential information to a proxy-health care worker or support staff outside of the examination room.

In yet other embodiments, an ecosystem of apps may provide for a link to the scribe controller interface for enhanced co-interactivity among patient and care providers, diagnostics, and other measurable. This interactive ecosystem or platform may provide the option to save the form session and, or form session analytics from the scribe controller back to a partner app. Another scenario may include a partner app layer configured to make predictive suggestions on session adjustments, path, and, or routines on the scribe controller interface based on the partner app profiles of user and, or subject (physician and, or patient).

Another layer may provide for a workflow automation tool for prompting the system to perform a task command, provided a trigger is activated. For instance, “IF” the treatment calls for a prescription for a steroid-based topical ointment, “THEN” auto-order the prescription for the ointment from a partnering pharmacy. In another embodiment, additional “AND”, “OR” operators may be embedded into the trigger script and, or task script. For instance, “IF” the treatment calls for a prescription for a steroid-based topical ointment, “THEN’ auto-order the prescription for the ointment from a partnering pharmacy “AND” auto-generate a primary-care referral to a partnering dermatologist. In yet another scenario, “OR” operators may be used instead of the “AND” operator. In yet other embodiments, any number of “AND” and, or “OR” operator may be used in a command function. Such an automation layer may add further efficiencies to the patient care-flow.

### Exemplary Interaction Flow:

While not shown in FIG. 1, the user interface enables the user 12 to perform one or more functional inputs such as uploading an input image or video, initiating a search, web browsing, opening programs, opening applications, co-browsing, co-browsing with input functionality, syncing with at least one other user device in a session and having cross-device input functionality, activating a drawing tool, activating a texting tool. While the back-end interface is coupled to the server through the network 14 for processing the input and identifying independent user input. In other embodiments, this network-coupled server may be cloud-based for safer and more enhanced provisioning—avoiding bandwidth bottlenecks and lowering network latency.

While also not shown in FIG. 1, the physical inputs may be achieved by any one of, or combination of, cursor-point control by a mouse and, or touch screen; keystroke control on either a hard-keyboard or soft-keyboard; scribing and, or drawing stroke control by a stylus or finger-mediated touch-screen; and voice-to-text, voice-to-stroke, and, or voice-to-graphic (with or without machine learning).

In another preferred embodiment of the present invention, the sessions module 25 generates input data modification from multiple independent input data streams via corresponding independent input devices 21, wherein each of the multiple input data streams are sent or received over a network by each of a corresponding plurality of computing devices; wherein the generating comprises simultaneously processing of a single or plurality of networked independent input data messages, such that the independent input data messages comprise information on positions and movements of each of the corresponding independent input devices 21 which generate the corresponding input data messages, and states of the multiple independent input device elements in real-time and create separate iterations based on the different group interactions.

Additionally, in an embodiment of the invention, the sessions module 25 may generate input data modification information from multiple input data streams via corresponding input devices 21, wherein each of the multiple input data streams are sent or received over a network 24 by each of a corresponding plurality of computing devices, wherein the generating comprises of simultaneous processing of a single or plurality of networked independent input data messages, or a plurality of input data from single devices, such that the independent input data messages comprise information on positions and movements of each of the corresponding input generating devices which generate the corresponding input data messages, and states of the multiple independent input device 21 elements in real-time and create separate iterations based on the different group interactions.

In yet another embodiment of the invention, the input data streams modified by the sessions module 25 may be travel in simultaneous directions, using multiple independent data pathways, thus enabling a simultaneous input and user interface manipulation. For example, in an embodiment, various forms of media can be modified and or edited collaboratively in real-time. For example, in case of digital photo editing or document editing, a local user can be using one set of user controls to apply filters to the image, while another remote user may be able to apply caption information to the image simultaneously in real time. Additionally, this collaborative function may be performed using multiple independent input devices 21 with multiple users. Another example, in case of a music editing, a local user uses a touch based independent device input 21 using two or three finger gestures creating multiple inputs from a single device to create a note, simultaneously, a remote user may be able to modify one key stroke of one figure gesture to edit a particular note and create a better sounding tone.

In another embodiment of the invention, a user may open multiple session modules 25 on a single or plurality of independent input devices 21 and work on them simultaneously either by syncing multiple sessions modules 25 to multiple users or individually. Additionally, a user can retrieve any session module 25 from the server 23 from any independent input device 21.

Additionally, in another embodiment of the present invention, co-gesturing may be used to point out or highlight tools to another user. The types of media that can be edited collaboratively includes, but is not limited to, video, text, audio, technical drawings, software development, 3D modeling and manipulation, office productivity tools, digital photographs, and multimedia presentations. In another embodiment, audio mixing can be performed in real time by musicians in remote locations, enabling the means to perform together, live, without having to be in the same location.

In yet another preferred embodiment of the present invention, the controller 22 executes a configured program to accept inputs from a plurality of the independent input devices 21, translate at least a first partial input into a messaging event, generate an independent input data stream from at least one of the first partial input, the messaging event, or a second partial input by the sessions module 25 and allow at least one cursor-point, keystroke, hand-gesture and, or touch-screen control across at least one virtual spaces from one or a plurality of independent device inputs by the virtual space module. Additionally, in another embodiment of the invention, the touch screen control may allow a use of a plurality of gestures, such as multiple fingers which distinguishes the input functionality from multiple independent input devices 21 not as a single point.

In yet another preferred embodiment of the invention, the virtual space module 26 may be further configured for co-browsing, co-texting, script-to-text or text-to-script and voice-to-text or text-to-voice interactivity among at least two users in a second defined virtual space. Additionally, the virtual space module 26 may be further configured for a drawing stroke interactivity among at least two users in a third defined virtual space thus, allowing the drawing layer to be the topmost layer of any virtual space. This may be followed by syncing of at least one of, applications, browsers, desktops, computer textual or graphical elements among at least two users in a third defined virtual space and or blocking of at least one of, texting, drawing, browsing or syncing to anyone or a plurality of users in a group session.

Further yet, in another preferred embodiment of the present invention, the virtual space module 26 is further configured to create defined co-virtual spaces of at least one interactive program, browser, application, or browsing interface, wherein each defined co-virtual space may be further overlaid with at least one of the interactive tool layers, whereby any and, or all independent user device inputs 21 may have independent functionality and distinct display across at least one defined co-virtual space and tool layer.

### Exemplary User Interface:

may control display of a script received from the application in the non-handwriting input area of the memo window. Upon detecting a touch on the text and the image, the controller may recognize the handwriting image input to the handwriting input area, convert the recognized handwriting image to text matching the handwriting image, and control a function of the application corresponding to the text. When the memo window is displayed over the button, the controller may control deactivation of the button.

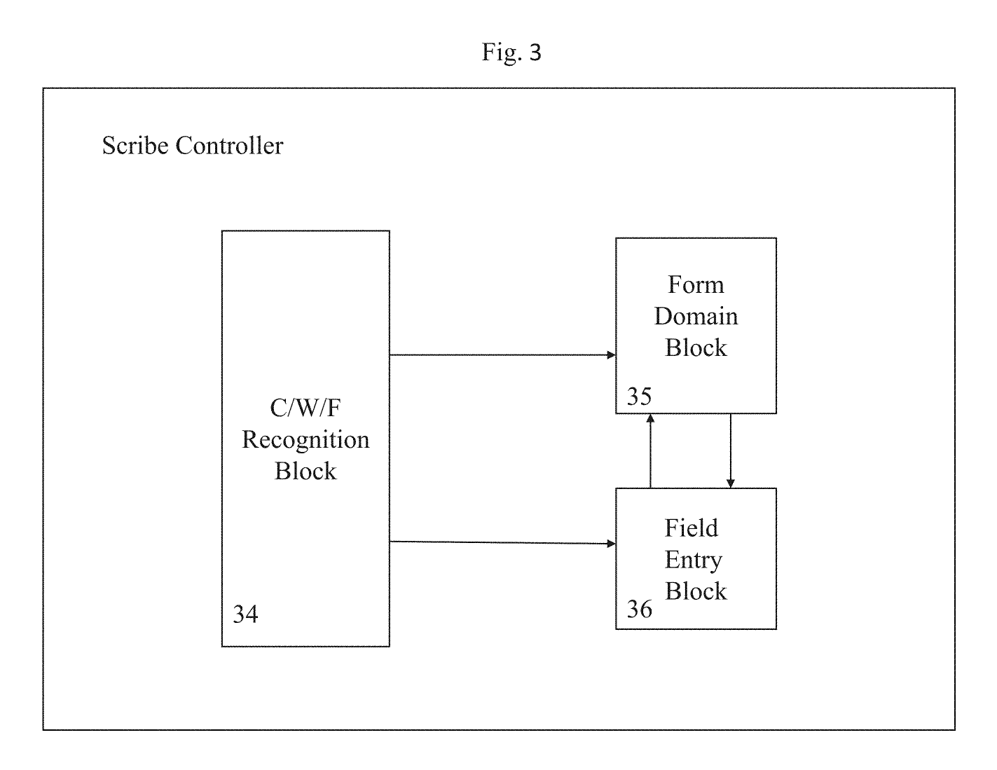

FIG. 3 show a screenshot of an exemplary virtual space interface. Virtual space display 32 is a display of a virtual space interface, which includes a query bar 32a centrally located. The query bar 32a may be a Boolean search of the world-wide web or a search of any variety of spaces and tool layers available on the system. The click tabs and drop down tabs 32b positioned within display 32 suggests the versatility of tools at the disposal of a group session. The click and drop down tabs 32b include a sign out tab, sessions tab, invite tab, chat tab, draw tab, files, site, sync, and manage tab. In one instance, by any one user clicking on a site tab, users may co-interface on that user's browser, while keeping applications and files on that user's desktop in the dark. If any one user were to click on the sync tab, now applications and files on a desktop of that user may be viewed and invoked for any operation by any other user in the session. Positioned above the click and drop-down tab is a URL address bar. The spatial relations of 32a and 32b are in accordance with an exemplary environment, however, other embodiments may have any one of a spatial relation.

Display 34 represents a private note display, only visible to user 1 corresponding to the user device input 1. Other users in the group may not view the private note display 34 of user 1. Display 36 may be a note or chat box associated with user 2, for instance, while display 38 may be a note or chat box associated with user 3, for instance. In one embodiment, a text box or chat box layer may include a private note display 34, only visible to the respective user. The layer may also include a group-wide text box 36, 38, each text box 36, 38 designated to the respective user, and visible to the entire group. Text boxes 34, 36, 38 may be designated with a color-code identifier corresponding to the color code of each respective user. Alternatively, the text box 36, 38 may be user designated by any one of user identifier or nomenclature. In yet other embodiments, the text box or chat box layer may display a private note box 34, along with one other text box, visible to the group. This one text box may allow users to input text into the single display, and each user may be designated by any one of a user identifier, nomenclature, and, or user-specific color-code.

Any number of note or chat boxes may be opened, depending on the number of users in the group. Each of these display windows 34, 36, 38 may be location sensitive, so that the displays are auto-positioned for maximal visibility given the user or group activity of a particular display and the size constraints of a given user display. Alternatively, user may choose display and size of chat boxes or any tool layer box by selecting a location within a particular virtual space display 32, 39 and invoking a tool function, can send a signal corresponding to that location to that particular virtual space display. For instance, user 1 may invoke a tool feature from the above click or drop-down tab feature 32b and locate within the virtual space display 32, 39 of interest. In other embodiments, the invoked tool from the click or drop-down tab features 32b will automatically appear in the last virtual space display active or highlighted 32, 39. In yet other embodiments, the click or drop-down tab features 32b may appear in the virtual space display 32 of interest. In yet other embodiments, the click or drop-down tab features 32b may appear on the interface display, and yet, not located within any one of virtual space display 32.

Once the tool feature 34, 36, 38 is positioned in any one particular virtual space display 32, user 1 may invoke an operation to which all users in the group will be able to view and edit in real-time. User 2 and, or user 3 . . . user n may each invoke a second and, or third . . . n tool feature using the same request, location, and operational mechanisms. Due to size constraints of each individual virtual space display 32, tool feature displays 34, 36, 38 may be positioned and minimized by a system-automated means or by any one of a user preference. The data structure associated with any one particular virtual space display of interest 32 may have a data structure bridging means to any one of a data structure associated with any one of a tool layer data structure.

In other embodiments, a tool layer transferring means may be a featured icon within a tool layer set 34, 36, 38 or featured icon within the click or drop down tab features 32b within the top tool-bar or abridged virtual space display of interest bar. Such a tool layering transferring means may allow a user to transfer invoked actions from one virtual space display, for instance 32, and impose onto another virtual space display, for instance 39. In yet other embodiments, a user may specify the number of invoked operations by the tool layer 34, 36, 38 to which the user wishes to further transfer and impose onto another virtual space display 32, 39. This allows for a discriminate transfer of invoked operations from one virtual display 32, 39 to another.

In other embodiments, a tool layer overlapping means allows for successively or non-successively displayed tool layers 34, 36, 38 that have at least some shared characteristics may appear as a single tool layer. This feature minimizes display clutter by overlapping and unifying tool layers 34, 36, 38 from respective users that share layer characteristics above a predefined threshold. In the event that a unified tool layer is displayed, varying layer characteristics may all be displayed. Conflicting characteristics may be brought to the attention of the group, by which the users may further resolve, or the system may display based on a first or last in time rule. Examples of shared characteristics may be tool layer type, invoked operation, position, common text, graphical element, data, etc.

Switching between virtual space displays 32, 39 and, or between tool layers 34, 36, 38 may be achieved by clicking the display of interest. Once active in a space or layer, the space or layer may be highlighted to indicate activity. In some embodiments, color-coding of the space or layer may be achieved to indicate the respective user occupying the space. Color-coding may also be employed to indicate group occupancy of a space or layer. In some embodiments, color-coding may distinguish between active and inactive spaces or layers.

In some embodiments, a display fade means may exist, configured to minimize or terminate space or layer displays that have been inactive above a predefined threshold of time or activity. Again, such a means allows for minimizing clutter against a space constrained display. In other embodiments, the display fade means may be configured for increasing opacity of the inactive displays, such that the inactive display may still be viewable, but not at the risk of being at the focus of any of the users.

Stacking of space and layer displays may be achieved by a display stacking means. Stacking may be invoked by any of the users, or by the system upon recognition of display size constraints. Stacking may be done in a staggered fashion, such that the top portions of each display are still visible in the stack, such that display switching may be efficient. Each display in the stack may expose an identifier on the top most portion of each display in order for a user to easily and efficiently choose displays within a display stack. Identifiers may be the entire saved or designated name of a virtual space display 32, 39 or tool layer display 34, 36, 38. Alternatively, identifiers may be any one of an abbreviation or any nomenclature of the saved or designated name. Furthermore, the display stacking means may be configured for only stacking spaces or layers that share display characteristics. Examples of shared characteristics may be virtual space type, tool layer type, invoked operation, position, common text, graphical element, data, etc. Grouped stacks based on shared characteristics may have a further identifier of any name, abbreviation, and, or nomenclature prominently displayed on a first display of a stack. The display stack means allows for minimizing display size constraints and delivering space and layer switching efficiencies.

Textual inputs may be color-coded to designate user. Textual inputs may also be user designated by end-noting with the user identifier. In other embodiments, a mark-up mode tracks all operations, edits, and, or modifications and designates the corresponding user identifier. In other embodiments, a clean mode displays the final version only. Sharing or embedding of a final deliverable may be done with a group tag or identifier. Recipients may receive deliverables with attribution to the specific group involved. Other group tags may further comprise of each user associated with a group. In some embodiments, saved sessions or particular saved deliverables may be queried or retrieved. Queries or retrieval may be done by session identifier, project or deliverable title, date/time, group identifier, and, or individual user identifier.

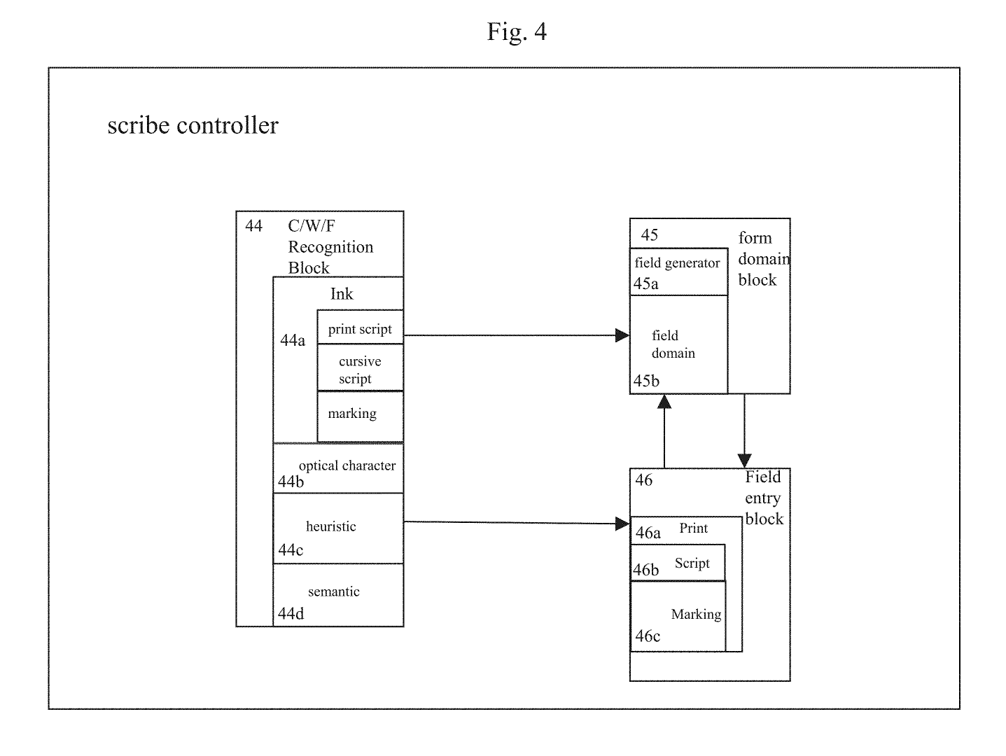

FIG. 4 illustrates a method flowchart of the virtual space interface in accordance with an aspect of the invention. The first step in the method flow begins at step 41, which calls for accepting inputs from a plurality of the independent device; translating at least a first partial input into a messaging event 42; generating an independent input data stream from any one of, or combination of, the first partial input, the messaging event, and, or a second partial input by the sessions module 18 43; and allowing any one of, or combination of, cursor-point, keystroke, and, or touch-screen control across any one of or more virtual spaces from any one of or more independent device inputs by the virtual space module 20 44, wherein the virtual space module 20 is further configured for: creating defined co-virtual spaces of any one of interactive program, application, and, or browse interfacing, wherein each defined co-virtual space may be further overlaid with any one of interactive tool layers, whereby any and, or all independent user device inputs have independent functionality and distinct display across any one of a defined co-virtual space and tool layer 45.

In other embodiments, the program executable by the controller 16, configures the controller to perform the following steps of (1) accepting inputs from a plurality of the independent device 41; computing a signature of the independent device input and assigning a unique identifying characteristic in the form of nomenclature, alpha-numeric identifier, and, or cursor color and display through the user interface with independent input functionality; and allowing any one of, or combination of, cursor-point, keystroke, and, or touch-screen control across any one of or more virtual spaces from any one of or more independent device inputs by the virtual space module 20 44, wherein the virtual space module 20 is further configured for: creating defined co-virtual spaces of any one of interactive program, application, and, or browse interfacing, wherein each defined co-virtual space may be further overlaid with any one of interactive tool layers, whereby any and, or all independent user device inputs have independent functionality and distinct display across any one of a defined co-virtual space and tool layer 45.

In other embodiments, the virtual space module may further be configured for performing any of the following steps of: interactive co-browsing among at least two users in a first defined virtual space; syncing of at least any one of, or combination of, applications, desktops, computer textual and, or graphical elements among at least two users in a second defined virtual space; and blocking of at least any one of, or combination of, browsing, and, or syncing to any one user in a group session.

In yet other embodiments, each of the virtual spaces, or any combination thereof, may further be over laid with any one of, or combination of the following tool layering steps: drawing stroke interactivity among at least two users in any one or more virtual spaces; scribing-to-text, texting-to-scribe, voice-to-text, voice-to-scribe, and voice-to-media, among at least two users in any one or more virtual spaces; and saving, querying, and retrieving sessions among at least two users; and each virtual space display and, or layering tool display may further be enriched with a means for performing any one of, or combination of, the following steps: stacking displays, switching between displays; relocating displays, fading inactive displays, transferring invoked tool operations from one display to another, color-coding displays, overlapping or unifying displays, and resizing of the displays. The use of tools may be prompted or suggested by the system intelligently based on the space in which the tool resides, based on individual use, and, or group use and behavior. Tool prompting and suggested use may also be based on a pre-defined rule or criteria.

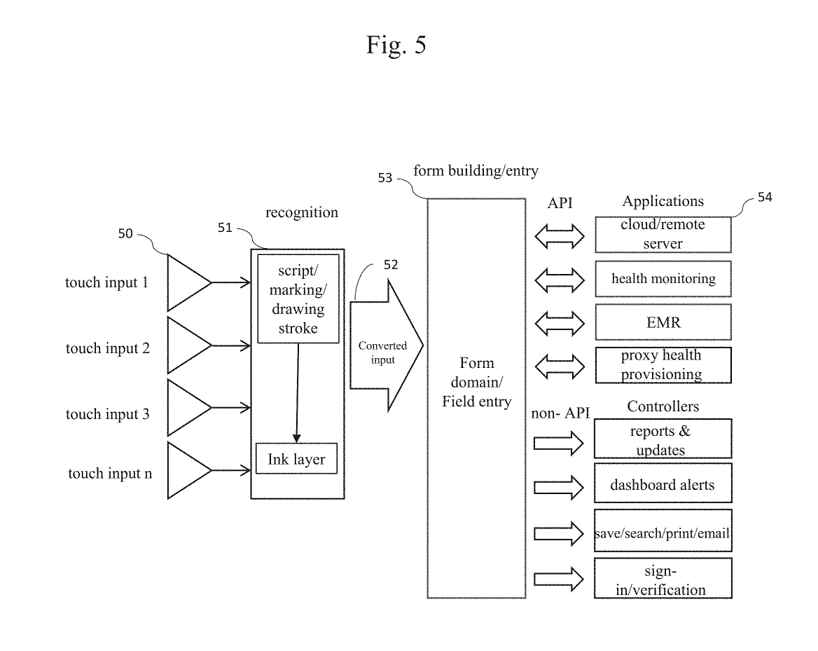

FIG. 5, illustrates an exemplary interaction flow in which various embodiments of the disclosure can be practiced. In a preferred embodiment of the invention, the touch inputs 50 recognizes a command and processes input from the user and provides the recognized command to the application executer. The scribe controller receives the touch input 50, recognizes the script, marking and or drawing stroke 51 and is converted and processed by the ink layer for a subsequent printing output 52 for an automatic and a fluid form building 53 capability. Additionally, in other embodiments, a completed form may have a RESTful Application Program Interface (API) coupled to client side adapted code that delivers each client side API pathway that specifically suits the client—based on context and load. This allows for 3rd party database integration, such as Electronic Medical Records (EMR), health monitoring, proxy health provisioning and other downstream analytics and provisioning. Additionally, the completed forms may be further saved onto a remote cloud based server for easy access for further downstream analytics and use.

In another embodiment of the invention, the scribe controller may allow for easy saving, searching, printing, and sharing of form information with authorized participants. Additionally, the scribe controller may allow for non-API applications, for example, building reports and updates, create dashboard alerts as well as sign in/verifications. Alternatively, sharing may be possible with less discrimination based on select privacy filters.

Further yet, in another embodiment of the invention, the recognition block 51, a part of the scribe controller may further comprise of a cessation layer which, detects a cessation of any one of a stroke, cursive, or drawing stroke input 51, and communicates to any one of the form domain block 53 and, or form entry block to finalize a first field domain and, or field entry and initiate a second field domain and, or field entry. Further yet, the cessation of any one of a stroke, cursive, or print script input is at least one second.

In another embodiment of the invention, the recognition layer 51 recognizes the drawing stroke input image using a pre-stored drawing stroke image library and a generated drawing stroke array list. Further yet, the recognition layer employs machine learning techniques in recognizing the drawing stroke input image.

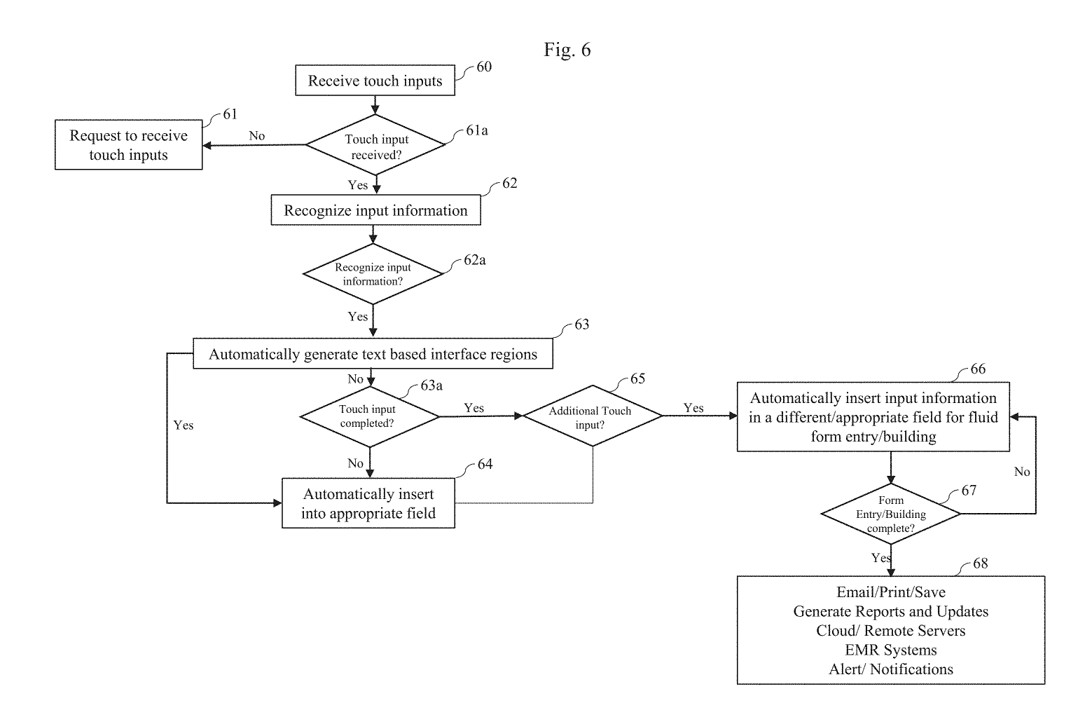

FIG. 6, illustrates an exemplary process flow according to an embodiment of the invention. As illustrated in FIG. 6, the user opens the application on any one of a plurality of handheld devices and/or wearable devices. A Wi-Fi connection is automatically established between any one or a combination of handheld and/or wearable device and the server (not shown). In a preferred embodiment of the invention, the user uses touch inputs to start a session. Once a user is invited to a session, each user may have a full display space to script a command for a conversion into a form field domain. Inputs 60 may be received onto the device from any one of finger-point script or drawing stroke control, and, or gesture-led control. Once the inputs are received 60 and recognized 62 by the device, a text based interface regions are automatically generated 63. Further yet, in another embodiment of the invention, if the touch input is not received 61a and/or recognized 62a, then a request is made to receive touch inputs 61. Additionally, in yet another preferred embodiment of the invention, once the text based interface regions are generated 63 and completed, they are automatically inserted into an appropriate field 64.

Alternatively, if the touch input is not completed 63a, then a request may be made for additional touch inputs 65. Further yet, in another preferred embodiment of the invention, the input information is automatically inserted into appropriate fields for a fluid form building/entry 66. The automatically filled out form may further be any one of the following; saved, printed, emailed, may be used to generate reports and updates, saved in cloud and remote servers for further use, used in EMR systems and or for alerts and notifications 68. Alternatively, if the form building/entry is incomplete 67, a request may be made to insert additional text based interface for a fluid form entry/building 66.

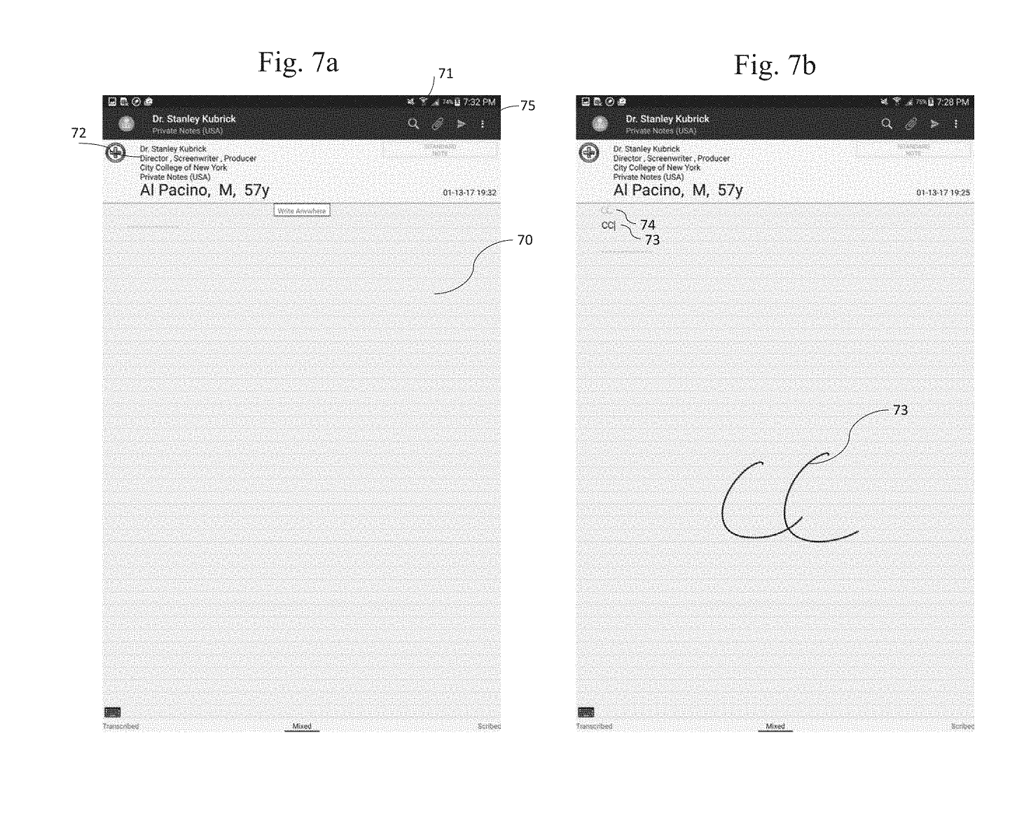

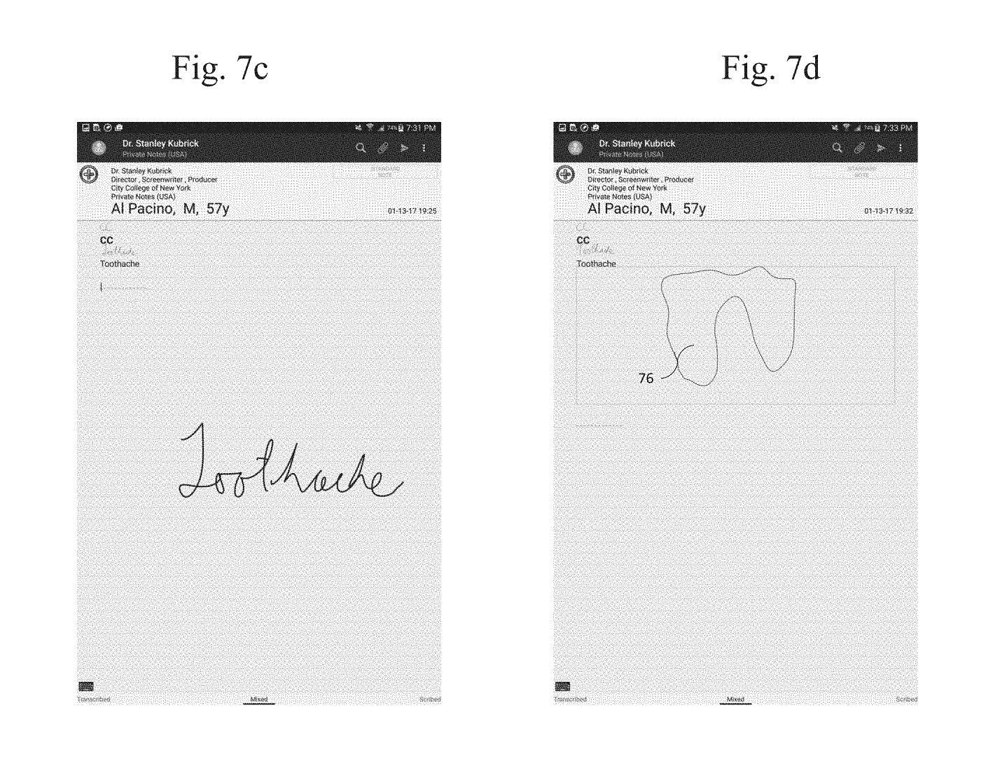

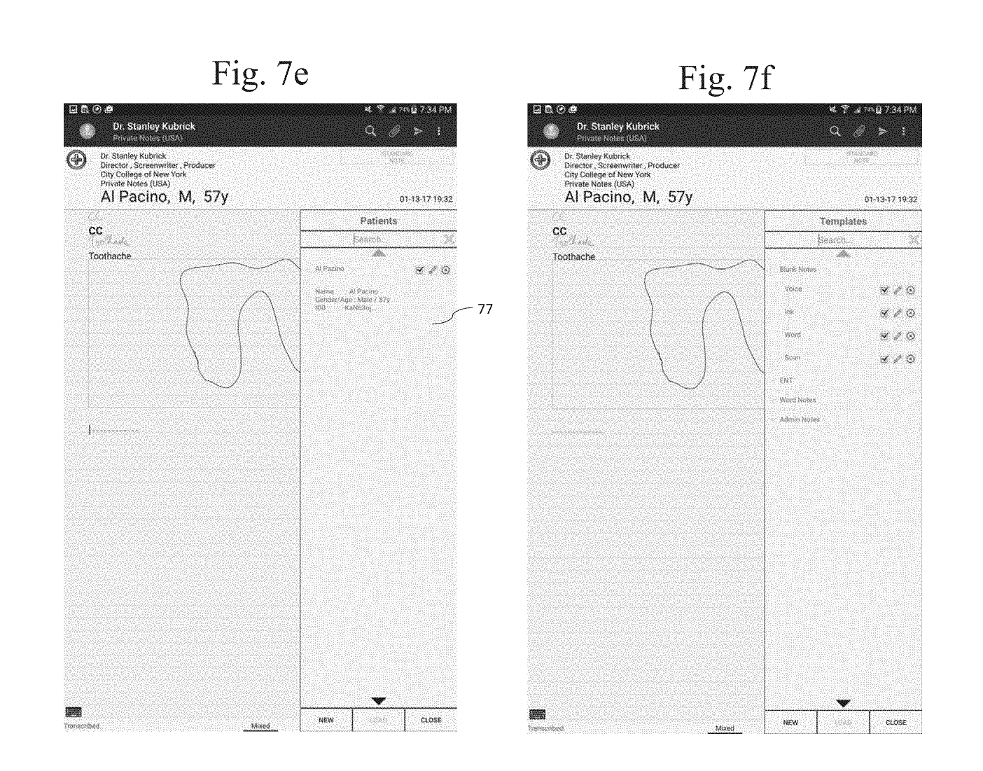

FIGS. 7a-f, shows a screenshot of a user interface virtual display according to an exemplary embodiment of the invention. In an embodiment of the invention, a user interface virtual display 70 is a display of a virtual space interface, which includes a query bar 71 located on the top of the interface display 70. The query bar 71 may be a Boolean search of the world-wide web or a search of any variety of spaces and tool layers available on the system. The click tabs and or the drop down tabs 75 suggests the versatility of tools at the disposal of a session. The click and drop down tabs 75 include a sign out tab, sessions tab, email tab, chat tab, draw tab, paint tab, insert tab, files, site, sync, and manage tab. In one instance, by any one user clicking on a site tab, users may co-interface on that user's browser, while keeping applications and files on that user's desktop, laptop, tablet, mobile and or wearable device in the dark.

To further explain the embodiments of the invention in FIG. 7 a-f, for example, a doctor maybe using the system for electronic docketing of patient medical records. As shown in FIG. 7a-b, the doctor uses a touch input and writes “cc (chief complaints)” and “toothache” by the patient anywhere on the virtual display 70. The scribe controller (shown in FIG. 2) receives the “CC” and “toothache”, accepts the touch input from the users' device touch-screen and generates a script layer or marking, which may be entered at any location on the user interface virtual display 70. Further yet in a continuing embodiment of the invention, the C/W/F recognition block recognizes any one of the script or marking stroke input and renders it into a messaging event for conversion into any one of a standard font text 73 or marking 74. The messaging event is eventually translated into any one of the standard font text 73 or marking 74 by any one of a print layer of the field entry block. Subsequently, the form entry block populates a chosen field with any one of the standard font text 73 or marking 74 by anyone of a print layer of the field entry block. Additionally, the user can use drawing mode to illustrate the location of a toothache by freely drawing 76 at any location on the user interface virtual display 70.

In a continuing reference, an embodiment in the present invention, the user interface virtual display 70 may have any one of, or a combination of, text boxes, chat boxes or an input panel 77 (shown in FIG. 7e) to add notes, converse with another user and or edit the touch inputs in real time. Additionally, the input panel for script or marking may either overlay or share interface display space with any one of, or combination of, an application window, candidate window, form layer, form field layer, and, or third-party application window. Further yet, the input panel 77 may, further comprise of an editing tool using a list of handwriting-based gestures for editing of the script, drawing or marking input.

In one embodiment, a text box, input panel or chat box layer may include a private note display 77, only visible to the respective user. The layer may also include a group-wide text box (not shown), each text box designated to the respective user, and visible to the entire group. Text boxes 77 may be designated with a color-code identifier corresponding to the color code of each respective user. Alternatively, the text box 77 may be user designated by any one of user identifier or nomenclature. In yet other embodiments, the text box or chat box layer may display a private note box, along with one other text box, visible to the group. This one text box may allow users to input text into the single display, and each user may be designated by any one of a user identifier, nomenclature, and, or user-specific color-code.

Textual inputs may be color-coded to designate a specific subheading in the form. Textual inputs may also be user designated by end-noting with the user identifier. In other embodiments, a mark-up mode tracks all operations, edits, and, or modifications and designates the corresponding user identifier. In other embodiments, a clean mode may only display the final version. Sharing or embedding of a final deliverable may be done with a group tag or identifier. Recipients may receive deliverables with attribution to the specific group involved. Other group tags may further comprise of each user associated with a group. In some embodiments, saved sessions or particular saved deliverables may be queried or retrieved. Queries or retrieval may be done by session identifier, project or deliverable title, date/time, group identifier, and, or individual user identifier.

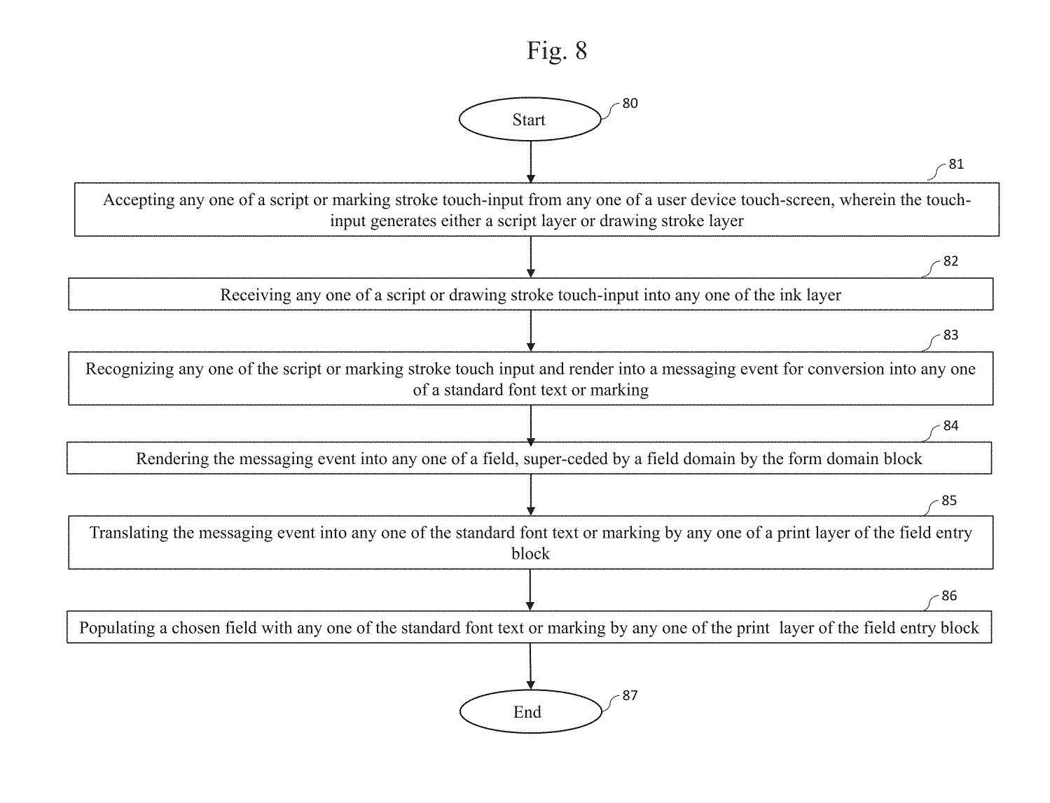

FIG. 8, depicts a method flowchart for processing the touch inputs into form and text across the scribe controller in accordance with an aspect of the invention. In an exemplary embodiment of the invention, the user uses touch inputs to start the application 80. Once the touch inputs are entered, the scribe controller accepts any one of a, script or marking stroke touch-input from any one of a user device touch-screen 81, wherein the touch-input generates either a script layer or drawing stroke layer. This is followed by receiving any one of a script or drawing stroke touch-input into any one of the ink layer 82 and recognizing of either the script or marking stroke touch input and rendering it into a messaging event for conversion into any one of a standard font text or marking 83. Further yet, in another embodiment of the invention, the scribe controller renders the messaging event into any one of a field, superseded by a field domain by the form domain block 84, followed by translating the messaging event into any one of the standard font text or marking by any of a print layer of the field entry block 85. Lastly, populating a chosen field with any one of the standard font text or marking by anyone of the print layer of the field entry block 86 completes the processing of the touch inputs into a form 87.

In an embodiment of the invention, a form at any point during transcription may be edited, saved, curated, searched, retrieved, printed, and, or e-mailed. Further yet, the completed form may be saved on a cloud based server and or may be further integrated with any one of, or combination of, electronic medical records (EMR), remote server, API-gated tracking data and, or a cloud-based server for down-stream analytics and, or provisioning.

Embodiments are described at least in part herein with reference to flowchart illustrations and/or block diagrams of methods, systems, and computer program products and data structures according to embodiments of the disclosure. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus, to produce a computer implemented process such that, the instructions which execute on the computer or other programmable apparatus provide steps for implementing the functions/acts specified in the block or blocks.

In general, the word “module” as used herein, refers to logic embodied in hardware or firmware, or to a collection of software instructions, written in a programming language, such as, Java, C, etc. One or more software instructions in the unit may be embedded in firmware. The modules described herein may be implemented as either software and/or hardware modules and may be stored in any type of non-transitory computer-readable medium or other non-transitory storage elements. Some non-limiting examples of non-transitory computer-readable media include CDs, DVDs, BLU-RAY, flash memory, and hard disk drives.

In the drawings and specification, there have been disclosed exemplary embodiments of the disclosure. Although specific terms are employed, they are used in a generic and descriptive sense only and not for purposes of limitation, the scope of the invention being defined by the following claims. Those skilled in the art will recognize that the present invention admits of a number of modifications, within the spirit and scope of the inventive concepts, and that it may be applied in numerous applications, only some of which have been described herein. It is intended by the following claims to claim all such modifications and variations which fall within the true scope of the invention.

1. A digital form generating and filling interface system comprising:
at least one touch-device input;
a scribe controller processing each touch-device input and generating at least one messaging event for generation of at least one form domain, field, and entry, said scribe controller further comprising;
a character, word, figure (C/W/F) recognition block;
a form domain block;
a field entry block;
a program executable by the scribe controller and configured to:
accept any one of a script or marking stroke touch-input from any one of a user device touch-screen;
receive any one of the script or marking stroke touch-input into an ink layer;
recognize any one of the script or marking stroke touch input and render into a messaging event for conversion into any one of a standard font text or marking;
render the messaging event into any one of a field, super-ceded by a field domain by the form domain block;
translate the messaging event into any one of the standard font text or marking by any of a print layer of the field entry block; and
populate a chosen field with any one of the standard font text or marking by anyone of the print layer of the field entry block.

2. The system of claim 1, wherein the ink layer further comprises a print script recognition layer; a cursive script recognition layer; and a marking recognition layer.

3. The system of claim 1, wherein the C/W/F recognition block further comprises a heuristic layer and a semantic layer.

4. The system of claim 1, wherein the C/W/F recognition block further comprises a candidate layer, whereby the candidate layer displays on a user interface at least one recognition candidate based on any one of the script or marking touch input.

5. The system of claim 3, wherein the heuristic layer recognizes shorthand script for any one of a translation into a field domain by the form domain block or text conversion for entry into a field by the field entry block.

6. The system of claim 3, wherein the semantic layer recognizes natural language syntax from a recognized print script or cursive print input for conversion for entry into a field by the field entry block.

7. The system of claim 1, wherein the ink layer employs machine learning techniques to recognize cursive script or print script input.

8. The system of claim 7, wherein recognition updates from machine learning update a library of recognized cursive script or print script input.

9. The system of claim 8, wherein the cursive recognition layer or the print script recognition layer is coupled to the library of recognized cursive script or print script input to recognize a cursive or print script input.

10. The system of claim 1, wherein the C/W/F recognition block further comprises a cessation layer, wherein said cessation layer detects a cessation of any one of a marking, cursive script, or print script input, and communicates to any one of the form domain block and, or field entry block to finalize a first field domain and, or field entry and initiate a second field domain and, or field entry.

11. The system of claim 10, wherein the cessation of a marking, cursive script, print script input is at least one second.

12. The system of claim 2, wherein the marking recognition layer recognizes the marking input image using a pre-stored marking image library and a generated marking array list.

13. The system of claim 12, wherein the marking recognition layer employs machine learning techniques in recognizing the marking input image.

14. The system of claim 1, wherein an input panel for script or marking either overlies or shares interface display space with any one of, or combination of, an application window, candidate window, form layer, form field layer, and, or third-party application window.

15. The system of claim 1, wherein the field domain block sequences field domains of a form based on any one of an order of script input, pre-defined form, and, or user input history.

16. The system of claim 1, further comprising an editing tool using a list of handwriting-based gestures for editing of the script or marking input.

17. The system of claim 1, wherein a form at any point during transcription may be edited, saved, curated, searched, retrieved, printed, and, or e-mailed.

18. The system of claim 17, wherein the form may be further integrated with any one of, or combination of, electronic medical records (EMR), remote server, API-gated tracking data and, or a cloud-based server for down-stream analytics and, or provisioning.

19. A non-transitory computer readable medium including computer executable instructions, wherein the instructions, when executed by a processor, cause the processor to perform a method comprising:
accepting any one of a script or marking stroke touch-input from any one of a user device touch-screen, wherein the touch-input generates either a script layer or drawing stroke layer;
receiving any one of a script or drawing stroke touch-input into any one of the ink layer;
recognizing any one of the script or marking stroke touch input and render into a messaging event for conversion into any one of a standard font text or marking;
rendering the messaging event into any one of a field, superseded by a field domain by the form domain block;
translating the messaging event into any one of the standard font text or marking by any of a print layer of the field entry block; and
populating a chosen field with any one of the standard font text or marking by anyone of the print layer of the field entry block.

20. A method of processing each touch-device input and generating at least one messaging event for generation of at least one form domain, field, and entry in a form generating and filling interface, said method comprising the steps of:
accepting any one of a script or marking stroke touch-input from any one of a user device touch-screen, wherein the touch-input generates either a script layer or drawing stroke layer;
receiving any one of a script or drawing stroke touch-input into any one of the ink layer;
recognizing any one of the script or marking stroke touch input and render into a messaging event for conversion into any one of a standard font text or marking;
rendering the messaging event into any one of a field, superseded by a field domain by the form domain block;
translating the messaging event into any one of the standard font text or marking by any of a print layer of the field entry block; and
populating a chosen field with any one of the standard font text or marking by anyone of the print layer of the field entry block.
